(19) United States
(12) Patent Application Publication
(10) Pub. No.: US 2024/0296202 A1
(43) Pub. Date: Sep. 5, 2024

(54) EFFICIENTLY CLUSTERING DATA POINTS WITH AN IN-MEMORY COMPUTING SYSTEM

(71) Applicant: International Business Machines Corporation, Armonk, NY (US)

(72) Inventors: Ghazi Sarwat Syed, Zurich (CH); Abbas Rahimi, Rüschlikon (CH); Abu Sebastian, Adliswil (CH)

(21) Appl. No.: 18/176,684

(22) Filed: Mar. 1, 2023

(51) Int. Cl. G06F 17/16; G06N 3/04; G06N 3/063; G06N 3/088

(52) U.S. Cl. CPC G06F 17/16; G06N 3/04; G06N 3/063; G06N 3/088

(57) ABSTRACT

A computer-implemented method to cluster data on an in-memory computing (IMC) system. The method includes determining, by an IMC system, centroid coordinate vectors as column vectors of dimension M, the column vectors representing normalized coordinates of initial centroids of clusters of the set of N points. The method includes storing N point coordinate vectors of dimension M across the memory systems, wherein the N point coordinate vectors represent normalized coordinates of the set of N points and can be represented as an M×N matrix. The method includes refining the centroid coordinate vectors by determining dot products of the column vectors with the matrix to obtain intermediate vectors of dimension N, determining row vectors in accordance with maxima of each column, performing dot products of the row vectors with a transposed matrix as second vector-matrix multiplications to obtain column vectors, and averaging each of the column vectors.

### BACKGROUND

The present disclosure relates to the neuromorphic hardware devices and methods of operating such devices, and in particular, to methods of clustering data points using in-memory computing devices having a crossbar array structure.

Artificial neural networks (ANNs) such as deep neural networks have transformed the field of machine learning by providing unprecedented performance in solving cognitive tasks. ANN operations typically involve matrix-vector multiplications (MVMs).

### SUMMARY

Disclosed is a computer-implemented system and method to cluster data points on an in-memory computing system. The method includes determining, by an in-memory computing (IMC) system, K centroid coordinate vectors as K column vectors of dimension M, the K column vectors respectively representing normalized coordinates of K initial centroids of K clusters of the set of N points, where the IMC system includes one or more IMC devices, each of the one or more IMC devices has a crossbar array structure including input lines and output lines interconnected at a cross-point defining cells, and each cross-point includes a memory system. The method also includes storing N point coordinate vectors of dimension M across the memory systems, wherein the N point coordinate vectors represent normalized coordinates of the set of N points and can be represented as an M×N matrix. The method further includes refining the K centroid coordinate vectors. The refining includes performing, by the IMC system, dot products of the K column vectors with the M×N matrix as first vector-matrix multiplications to obtain K intermediate vectors of dimension N, the intermediate vectors forming a K×N matrix. The refining also includes determining K row vectors in accordance with maxima of each column of the K×N matrix. The refining further includes performing, by the IMC system, dot products of the K row vectors with a transposed version of the M×N matrix as second vector-matrix multiplications to obtain K column vectors and averaging each of the K column vectors according to values of components of respective ones of the K row vectors to obtain K averaged column vectors, the latter corresponding to the refined, K centroid coordinate vectors. Further aspects of the present disclosure are directed to systems and computer program products containing functionality consistent with the method described above.

The present Summary is not intended to illustrate each aspect of, every implementation of, and/or every embodiment of the present disclosure.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 is a diagram representing various entities (clients) interacting with a distributed computing system including in-memory computing (IMC) devices that are configured as edge devices to perform clustering tasks in accordance with client requests, in accordance with some embodiments of the present disclosure.

FIG. 2 schematically represents selected components of an IMC device having a crossbar array structure, in accordance with some embodiments of the present disclosure.

FIG. 3 is a diagram illustrating the operation of the IMC device of FIG. 2 to efficiently cluster data points, in accordance with some embodiments of the present disclosure.

FIG. 4 schematically represents an IMC system including two cascaded IMC devices, in accordance with some embodiments of the present disclosure.

FIG. 5 is a flow of vector-matrix operations performed to refine centroid coordinates of clusters, in accordance with some embodiments of the present disclosure. The numbers of vectors, data points, and their dimensions, are purposely small, for the sake of illustration.

FIG. 6 is a 3-Dimensional plot of the data points and initial cluster centroid coordinates as used in FIG. 5, in accordance with some embodiments of the present disclosure.

FIG. 7 is a flowchart illustrating high-level operations of a clustering method, according to embodiments of the present disclosure.

FIG. 8 is a block diagram of a computing environment suitable for clustering data points on an in-memory computing device, in accordance with some embodiments of the present disclosure.

The accompanying drawings show simplified representations of systems, devices, or parts thereof, as involved in embodiments. Technical features depicted in the drawings are not necessarily to scale. Similar or functionally similar elements in the figures have been allocated the same numeral references, unless otherwise indicated.

### DETAILED DESCRIPTION

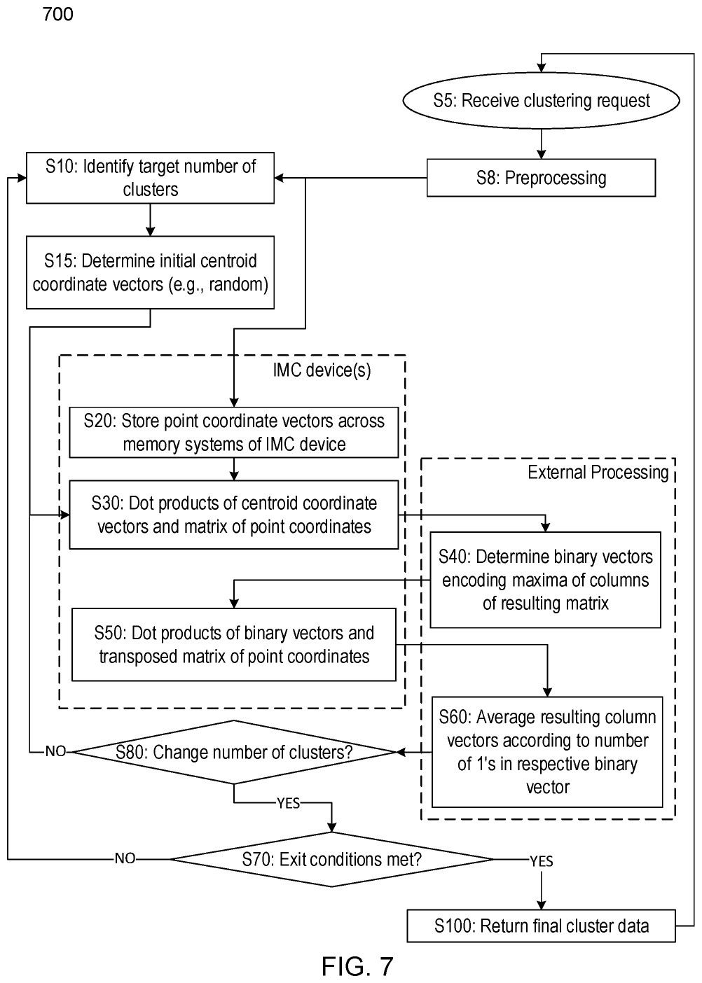

Computerized systems and methods embodying the present disclosure will now be described, by way of non-limiting examples. Note, the present method and its variants are collectively referred to as the “present methods”. All references Sn refer to methods operations of the flowcharts of FIG. 7, while numeral references pertain to devices, components, and concepts, as involved in embodiments of the present disclosure.

The present disclosure relates to neuromorphic hardware devices and methods of operating such devices, and, in particular, to methods of clustering data points using in-memory computing devices having a crossbar array structure. Vector-matrix multiplication can be based on normalized coordinates of data points that are permanently stored across memory devices of the in-memory computing devices.

Artificial neural networks (ANNs) such as deep neural networks have transformed the field of machine learning by providing unprecedented performance in solving cognitive tasks. ANN operations typically involve matrix-vector multiplications (MVMs). Such operations pose multiple challenges, because of their recurrence, and their relatively high compute and memory requirements. Traditional computer architectures are based on the von Neumann computing concept, according to which processing capability and data storage are split into separate physical units. This architectural concept suffers from congestion and high-power consumption, as data must be continuously transferred from the memory units to the control and arithmetic units through interfaces that are physically constrained and costly.

Embodiments of the present disclosure can use dedicated hardware acceleration devices, such as in-memory computing (IMC) devices to accelerate MVMs. The hardware can include a cross bar array structure. This type of circuit includes input lines and output lines, which are interconnected at cross-points defining cells. The cells contain a memory element or sets of memory elements forming memory systems, where each memory system is configured/designed to store respective matrix coefficients. Such an architecture can simply and efficiently map MVMs. Vectors are encoded in signals, which are applied to input lines of the crossbar array to efficiently perform the MVMs as multiply-accumulate (MAC) operations. The weights are updated by reprogramming the memory elements, as needed, to perform the successive MVMs. Such in-memory computing devices break the “memory wall” as they fuse the arithmetic and memory unit into a single IMC unit, thereby reducing at least some of the constrained and costly transfer relative to Von Neumann configurations.

Another advantage of crossbar array structures is that they can be configured to support transposed matrix operations, something that is usually exploited to train ANNs. In principle, however, the key computer primitive enabled by such devices can also be used for other applications such as solvers for systems of linear equations.

Besides ANNs and supervised learning methods, machine learning includes a variety of cognitive models and algorithms, starting with unsupervised learning methods, which consider unlabeled data points as input to reveal structure in the data. An important class of unsupervised learning methods concerns clustering algorithms. Cluster analysis aims at assigning observations to clusters (i.e., subsets), whereby observations assigned to a same cluster are more similar to each other than observations assigned to different clusters. Various clustering algorithms exist. Of particular importance are the so-called centroid models. For example, the k-means algorithm represents each cluster by a single mean vector. Such algorithms are usually implemented using conventional computer hardware, based on the von Neumann computing concept.

Embodiments of the present disclosure can use a clustering method relying on an in-memory computing (IMC) system. The IMC system includes one or more IMC devices, each having a crossbar array structure. A crossbar array structure comprises input lines and output lines, which are interconnected at cross-points, each cross point defining a cell. The cross-points include memory systems (e.g., memory elements or sets of memory elements). Embodiments of the disclosure can be configured to cluster a set of N points.

In some embodiments the method comprises determining K centroid coordinate vectors as K column vectors of dimension M. The K column vectors respectively represent normalized coordinates of K initial centroids of K clusters of the set of N points. In addition, the method stores N point coordinate vectors of dimension M across the memory systems. The N vectors represent normalized coordinates of the set of N points. The point coordinate vectors can be represented as an M× N matrix. In some embodiments, the method refines the K centroid coordinate vectors by performing successive operations, some of which involve the IMC system.

In some embodiments, dot products of the K column vectors with the M×N matrix are performed, using the IMC system, as first vector-matrix multiplications. This leads to K intermediate vectors of dimension N. The intermediate vectors form a K×N matrix. Next, K row vectors are determined in accordance with maxima of each column of the K×N matrix. The IMC system is then used again to perform dot products of the K row vectors with a transposed version of the M× N matrix, as second vector-matrix multiplications, to obtain K column vectors. Finally, each of the K column vectors is averaged according to values of component of respective ones of the K row vectors. This way, K averaged column vectors are obtained, which correspond to the refined, K centroid coordinate vectors. The refinement of the centroid coordinate vectors can possibly be iterated.

In some embodiments, the K row vectors are determined as K binary vectors, which encode maxima of each column of the K×N matrix as ones, while remaining vector components consist of zeros. In that case, each of the K column vectors is averaged according to the numbers of ones in respective ones of the K binary vectors. The K row vectors can advantageously be determined by comparing output signals obtained from analog-digital converters in said output lines upon performing the first vector-matrix multiplications.

In some embodiments, the IMC system includes an IMC device that supports transposed matrix operations, whereby the first vector-matrix multiplications and the second vector-matrix multiplications are performed using a same memory configuration of the N point coordinate vectors as stored across the memory systems of this IMC device.

In some embodiments, the calculations can be performed as part of an information processing system configured to cluster a set of N points. The information processing system includes an IMC system which can include one or more IMC devices (or tiles), each having a crossbar array structure including input lines and output lines interconnected at cross-points defining cells, the cross-points comprising respective memory systems. The IMC system further includes a processor, which are connected to the IMC system. Consistently with the above methods, the processor is configured to determine K centroid coordinate vectors, operate the IMC system to store N point coordinate vectors across its memory systems, and refine the K centroid coordinate vectors by performing operations as described above, i.e., performing the first vector-matrix multiplications, determining the K row vectors, performing the second vector-matrix multiplications to obtain K column vectors, and averaging the latter to obtain the refined, K centroid coordinate vectors.

The IMC system may notably include one or more IMC devices that support transposed matrix operations. The processor(s) may possibly include processing units that are configured as near-memory processing units with respect to respective ones of the IMC devices.

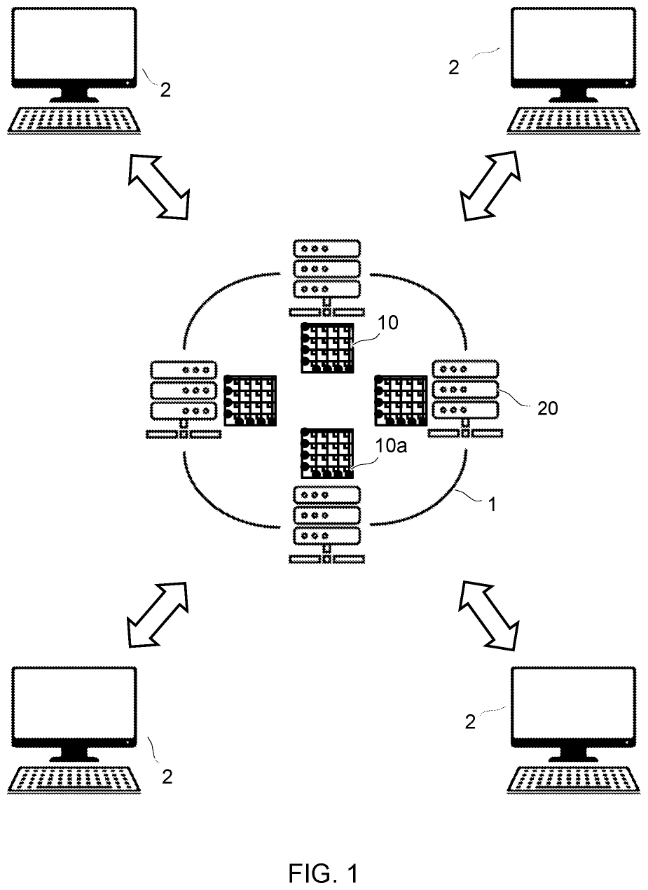

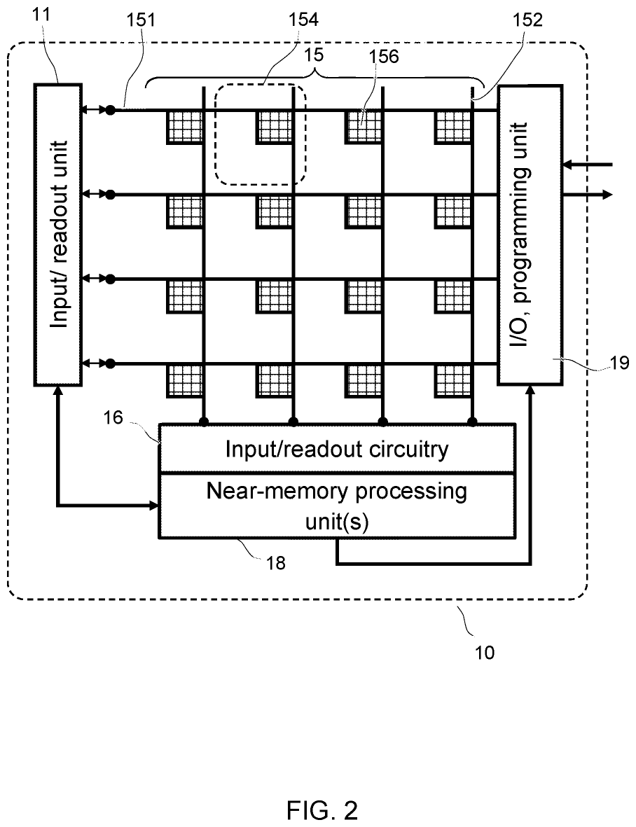

Various embodiments of the disclosure will now be described in detail, in reference to FIGS. 1-7. This aspect concerns a method of clustering a set of N points using an in-memory computing (IMC) system 10. The IMC system includes one or more IMC devices 10, such as depicted in FIG. 1 and FIG. 2.

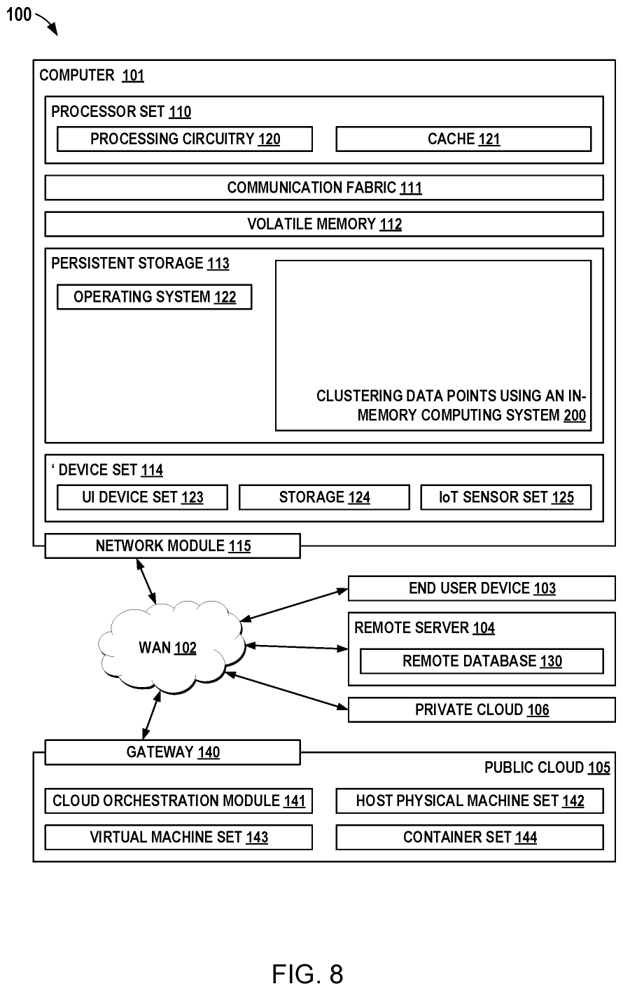

FIG. 1 depicts an information processing system. The information processing system includes distributed computing system (or system) 1 and various entities (clients 2) interacting with one or more information processing system 20, where each information processing system 20 includes at least an in-memory computing (IMC) device labeled as 10 and/or 10a. The IMC devices can be configured as edge devices to perform clustering tasks in accordance with client 2 requests. In some embodiments, each client 2 and/or information processing system 20 can include a computer 101 of FIG. 8. In some embodiments, there can be any number of IMC systems 10, (e.g., IMC system 10a, IMC system 10b, etc.).

In some embodiments, the system 1 may be configured as a composable disaggregated infrastructure, which may further include other hardware acceleration devices, (e.g., application-specific integrated circuits (ASICs) and/or field-programmable gate arrays (FPGAs)). Several architectures can be contemplated for various embodiments of the overall system 1. For example, the present system 1 may be configured as a standalone system or as a computerized system connected to one or information processing system 20. As said, the system 1 may, for instance, be configured as a distributed computing system, such as an edge computing system. In particular, the distributed computing system 1 may possibly involve several conventional computers 20, paired with respective IMC system 10, where the IMC system 10 is configured as edge devices, to concurrently serve multiple queries from clients 2, as assumed in FIG. 1. Moreover, the present methods may possibly be implemented through hardware resources available in a cloud.

In that respect, the present methods can advantageously be performed online, in response to client queries. More generally, however, the present methods can be performed online or offline. Clustering operations can be performed for a range of applications including market segmentation, document clustering, image segmentation, compressions, financial transactions, and data embedding in neural networks.

FIG. 2 depicts one embodiment of IMC device 10. FIG. 2 includes near memory processing unit 18 and programming unit 19. In some embodiments, each processing unit 18 is configured as near-memory processing units with respect to a respective IMC devices 10. In some embodiments, programming unit 19 may be connected at an output of the near-memory processing unit 18 to allow a closed-loop programming of the crossbar array structure 15. In variants, the processing unit 18 and the programming unit 19 are implemented as one and a same unit. The programming unit 19 may further include an input/output (I/O) controller and be configured to communicate with external devices or computers. In some embodiments, processing unit 18 is connected in output of the crossbar array 15 through an output of a readout circuitry 16.

Each IMC device has a crossbar array structure 15. The array structure 15 can include input lines 151 and output lines 152, which are interconnected at cross-points defining cells 154. Each of the cross point cells 154 cross-points include a memory system 156. The input and output lines are interconnected via memory systems 156. FIG. 2 also includes input/readout unit 11 and input/readout circuitry 16. In various embodiments, input/readout unit 11 and input/readout circuitry 16 can act as both inputs and/or outputs to array structure 15.

The IMC device 10 of FIG. 2 also includes input lines 151 and output lines 152, which are interconnected at cross-points (i.e., junctions). The cross-points accordingly define cells 154 (also called unit cells). The input and output lines are interconnected via memory systems 156. In principle, at least two input lines and two output lines are needed to define an array. In practice, however, the number of input lines 151 and output lines 152 will typically be on the order of several hundreds to thousands of lines. For example, arrays of 256×256, 512×512, or 1024×1024 may be contemplated, though the array does not necessarily need to be a square array. Each memory system 156 may include one or more groups of memory elements, which are arranged in parallel in their respective groups. Each input (respectively output) line may subdivide into a number of conductors, which connect to (respectively from) respective memory elements of each cell. So, each input (or output) line may include several parallel electrical conductors.

The N point coordinate vectors are stored across the memory systems 156 using a programming unit 19. For example, each multidevice cell can be programmed one after the other. Programming a cell means storing a target weight value in this cell. The target weight value may, for instance, be converted in an electrical conductance value. In that case, the aim is to program memory elements of each cell for the corresponding memory elements to yield a summed conductance value matching a target conductance value corresponding to the target weight value to be stored in that cell. In the above example, weight values are meant to be mapped to conductance values of the memory elements, meaning that the IMC device relies on analog memory systems. The memory elements can for instance be phase-change memory devices, resistive random-access memory devices, or flash memory cell devices. In principle, however, digital memory elements can be used too.

The IMC system may possibly include a plurality of IMC devices 10, 10a, as discussed earlier. Each IMC device 10, 10a may include a processing unit 18, connected at an output of the crossbar array 15, i.e., at an output of a readout circuitry 16, as illustrated in FIG. 2. This processing unit 18 is preferably arranged as a near-memory processing unit. In that case, the programming unit 19 may advantageously be connected at an output of the near-memory processing unit 18, to allow a closed-loop programming of the crossbar array structure 15. In variants, the processing unit 18 and the programming unit 19 are implemented as one and a same unit. The programming unit 19 may further include an input/output (I/O) controller and be configured to communicate with external devices or computers, as suggested in FIG. 2.

In addition, the information processing system 20 may include further processing capabilities (see FIG. 1), which are connected to the IMC device(s) 10, 10a. As explained earlier in reference to the previous aspect of the disclosure, the processor 18, and/or processing system 20 are, as a whole, notably configured to determine K initial centroid coordinate vectors. The processor 18, and/or processing system 20 are further configured to operate the IMC system 10, 10a to store adequate values of the N point coordinate vectors across the memory systems 156 of the device(s) 10, 10a. Moreover, the processor 18, processing system 20 are configured to refine the K centroid coordinate vectors by: performing the first and second vector-matrix multiplications, using the IMC system 10, 10a; and determining the K row vectors; and averaging the K column vectors to update the K centroid coordinate vectors.

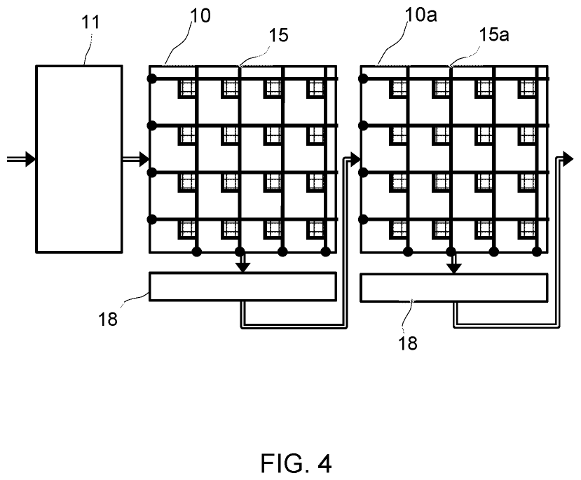

In some embodiments, two or more IMC devices (e.g., IMC device 10 and IMC device 10a (and/or array structure 15,15a)) can be used in a cascaded configuration, as depicted in FIG. 4. (The term “tiles” can be used to describe an IMC 10 and/or an array structure 15). The tiles 15 and 15a (or 10 and 10a) are then operated in series. A first tile (e.g., tile 15) is used for the forward pass, while the second tile (e.g., tile 15a) is used for the backward pass. The second tile stores a transposed version of the coordinate matrix stored in the first tile. Yet, it is not necessary to reprogram the coordinate values stored across the memory systems 156 of the tile 15, (or tile 15a).

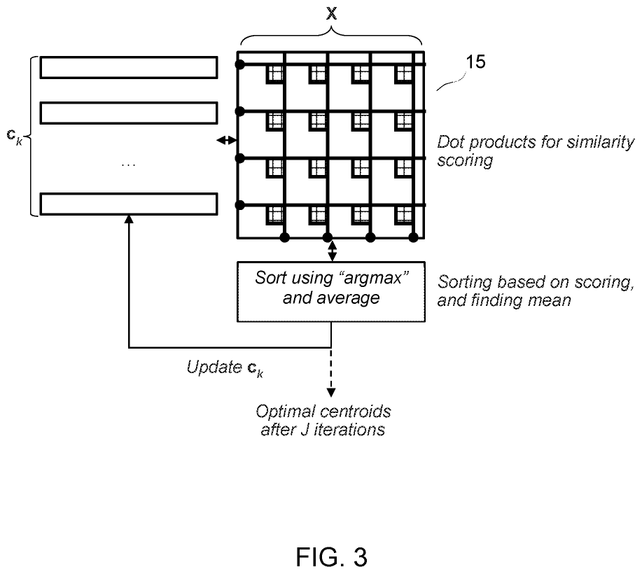

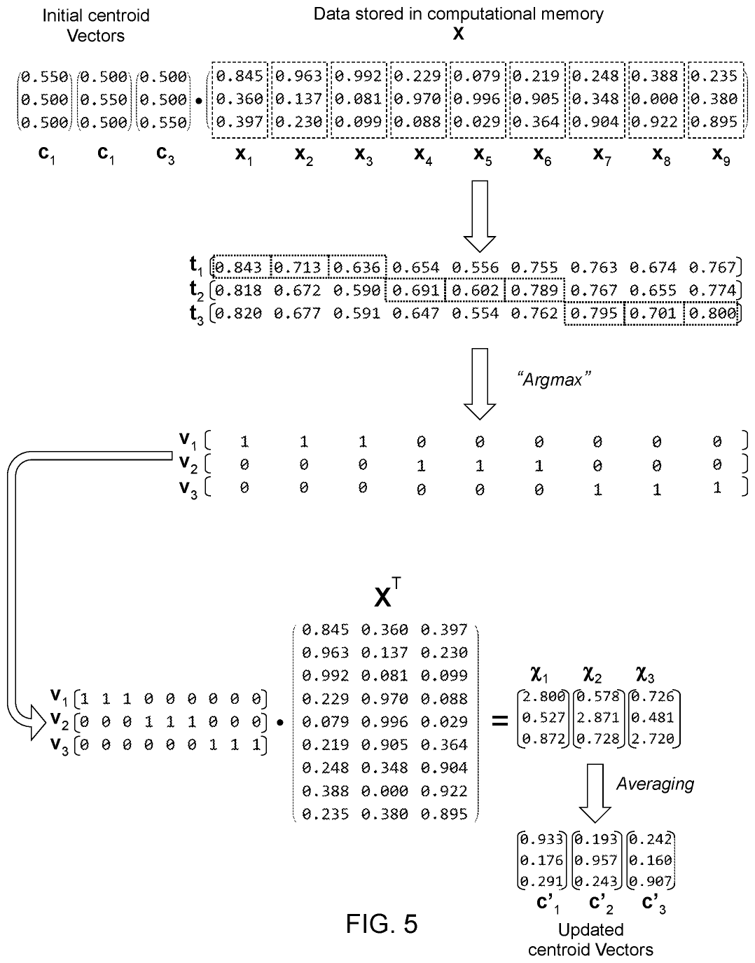

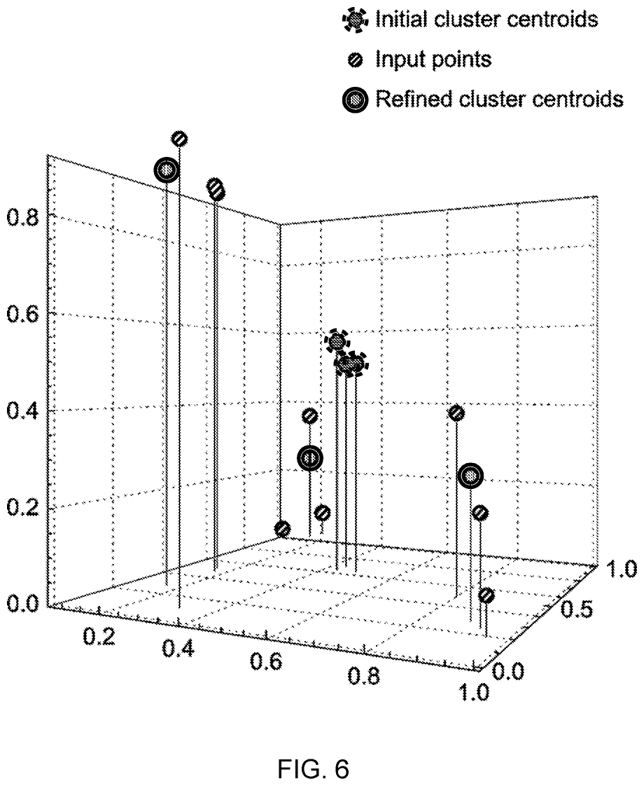

The operations of the method 700 are shown in the flow of FIG. 7. Some of these operations are summarized in the diagram of FIG. 3 and illustrated in FIG. 5 (e.g., s15-s60), as an example of one embodiment. FIG. 3 includes an IMC 15 and shows the data flow through one IMC device. Such operations comprise storing (operation S20) N point coordinate vectors of dimension M across the memory systems 156. The N point coordinate vectors represent normalized coordinates of the set of N points. Such coordinate vectors can be represented as an M× N matrix, noted X in FIG. 5. In this simple example, M=3 and N=9. That is, nine points x₁ . . . x₉ are to be clustered in a space of dimension 3, see FIG. 6. The point coordinates are normalized, meaning that the corresponding coordinate vector components are between 0 and 1, e.g., using a min-max scaler. More generally, the input data may be subjected to some preprocessing (operation S8). The preprocessing can involve cleaning, feature extraction, dimension reduction, and/or normalization.

In parallel to operation S20, the method further comprises determining (operation S15) K centroid coordinate vectors. Such vectors are determined at S15 as K column vectors of dimension M. The K column vectors respectively represent normalized coordinates of K initial centroids of K clusters of the set of N points. The normalization scheme used to rescale the centroid coordinate vectors must be consistent with that used to rescale the point coordinate vectors. In the example of FIG. 5, K=3. That is, in this example, one seeks to obtain three clusters, the centroids of which are initially set close to the center {0.5, 0.5, 0.5}. The centroid vectors are denoted by c₁, c₂, c₃ in FIG. 5 and for a set C. Note, operation S15 can possibly be performed before, after, or in parallel with operation S20.

Next, the K centroid coordinate vectors are refined S30-S70 by performing a series of operations, some of which involve the IMC system 10, 10a. To start with, the IMC system 10 is used to perform S30 dot products of the K column vectors cₖ with the M×N matrix X subtended by the N point coordinate vectors xₙ. The dot products are performed as vector-matrix multiplications (here referred to as first vector-matrix multiplications), similar to the concept of matrix-vector multiplications. Note, each vector cₖ is multiplied to the M×N matrix. This gives rise to K intermediate vectors of dimension N, denoted by t₁, t₂, t₃ in FIG. 5. Such vectors are effectively row vectors and form a K×N matrix. Then, K row vectors vₖ are determined S40 in accordance with maxima of each column of the K×N matrix, e.g., as binary vectors where column-wise maxima are encoded as ones (i.e., values equal to 1), see FIG. 5.

In some embodiments, additional vector-matrix multiplications are subsequently performed at S50 through one or more of the IMC system 10. Such operations are referred to as second vector-matrix multiplications. They consist of dot products of the K row vectors with a transposed version of the M×N matrix, noted XT in FIG. 5. This further operation leads to K column vectors, noted χ₁, χ₂, χ₃ in FIG. 5. Each of the K column vectors is finally averaged S60 in accordance with values of component of the respective K row vectors (e.g., the respective numbers of ones). This leads to K averaged column vectors, corresponding to refined versions of the K centroid coordinate vectors, noted c′₁, c′₂, c′₃ in FIG. 5.

In other words, the present method relies on an in-memory computation engine to achieve a data clustering based on a spherical coordinate scoring method. The spherical coordinate scoring results from the normalization scheme employed, whereby the first vector-matrix operations are equivalent to cosine similarity operations. The proposed scheme establishes a similarity scoring between the input vector centroids and the data points, typically with O(1) time complexity. The k centroids can advantageously be updated with O(k) time complexity, for a single iteration. A single iteration may already suffice to obtain reasonably accurate centroid coordinates, see FIG. 6. In practice, however, the centroid coordinates can be iteratively refined, by repeating operations S30-S60.

The embodiments in this disclosure have several advantages. First, the first and second vector-matrix multiplications are efficiently performed through the one or more IMC system 10, 10a—in some embodiments, possibly a single IMC device (i.e., a single tile), so long as the single IMC device can support transposed matrix operations. All the more, in some embodiments, of a proposed solution is that the data points can be stored, once and for all, across the memory systems 156 of the IMC arrays 15, 15a. As such, the normalized data point coordinates do not need to be erased and rewritten to the IMC arrays throughout the computations. Even where the centroids are iteratively updated, the data point coordinates do not need to be moved during the successive iterations.

As illustrated in FIG. 5, the K row vectors may simply be determined S40 as K binary vectors, i.e., vectors that encode maxima of each column of the K×N matrix as ones (i.e., “1”), while remaining vector components consist of zeros (“0”). In that case, each of the K column vectors is averaged S60 according to the numbers of ones (“1”) in the corresponding K binary vectors. That is, each column vector χₖ is divided by the sum of ones (“1”) in the corresponding binary vector. In the example of FIG. 5, this amounts to dividing each column vector χₖ by three since the total of the elements of each vector χₖ is equal to three in this example.

Encoding maxima of each column of the K×N matrix as ones is equivalent to applying the function “argmax”, as defined by, e.g., the numpy.argmax function of the NumPy library, except that, here, the value 1 is returned in respect of the index of the maximum value of the column vector, while the value 0 is returned for other indices. In the following, such a function is referred to as the “argmax” function, although it slightly differs from the function “argmax” as usually defined in mathematics.

For instance, a possible algorithm is the following:

Algorithm 1
Argmax Function

```
A set X of N input data vectors, X = {x₁, ..., x_{N}}, are stored in the
memory systems of an IMC device
A set C of K centroids, C = {c₁, ..., c_{K}}, are randomly initialized as
candidate solutions (queries)
A set V of binary vectors V = {v₁, ..., v_{K}}, are randomly initialized
Forward pass
for i = 1 to some iteration length do
  for k = 1 to K do
  perform first vector-matrix multiplications (VMM) as VMM = cₖ.X
  ∀ₖ ∈ {1, ..., K}
  Compute Argmax(VMM(cₖ)) ∀ₖ ∈ {1, ..., K}
  Update V
  end for
end for
Backward pass
for k = 1 to K do
compute C′= {c′₁, ..., c′_{K}}, where c′k = vₖ.X ∀ₖ ∈ {1, ..., K}
Average and update C as cₖ = c′ₖ/Σ{vₖ = 1} ∀ₖ ∈ { 1, ..., K}
end for
Return C
```

Note, the above approach assumes that use is made of a correct number of input clusters; e.g., an over-provisioned number of clusters may lead to one or more row vectors vₖ containing only zeros. Such vectors would accordingly be discarded. A correct number of clusters may initially be inferred, at operation S8, using a simplified clustering method, if necessary.

In variants to binary vectors, other approaches may use more sophisticated weighting schemes, based on transformed values of the components of each column of the K×N matrix. However, using binary vectors is simpler, thus faster, and already accurate. In that respect, binary vectors can be used quickly by leveraging outputs of analog-digital converters (ADCs) arranged in the output lines 152 of the IMC device 10. Namely, the K row vectors may be determined S40 by comparing output signals obtained from the ADCs upon performing S30 the first vector-matrix multiplications. For each output line of the IMC, a nearby ADC digital unit provides a way to create a binary ID vector for each k^{th} input. A zero in the vector corresponds to columns for which the inner dot product is not maximal or above a user defined threshold value among the k VMM operations and vice versa.

As noted earlier, an outstanding feature of some embodiments of the present disclosure is that the N point coordinate vectors can be stored across the memory systems 156 of the IMC device(s) 10, (10a), irrespective of the number of IMC devices used. In some embodiments, a single IMC device 10 may possibly be relied upon, should this device support transposed matrix operations. In that case, the first vector-matrix multiplications and the second vector-matrix multiplications are performed S30, S50 using the same memory configuration of the N point coordinate vectors as stored across the memory systems 156 of this IMC device 10. Thus, the same tile can be used during the forward and backward pass, without it being needed to reprogram the values stored across the memory systems 156.

For example, when using an IMC device 10 as shown in FIG. 2, the first vector-matrix multiplications can be performed S30 by: (i) applying electric signals encoding values of components of the K column vectors along the input lines 151 of the crossbar array structure 15 of the IMC device 10; and (ii) measuring electric signals along the output lines 152 of the crossbar array structure 15. Conversely, the second vector-matrix multiplications can be performed at S50 by: (i) applying electric signals encoding values of components of the K row vectors along the output lines 152 of the crossbar array structure 15; and (ii) measuring electric signals along input lines 151 of the crossbar array structure 15. In that case, the input unit 11 and the readout circuitry 16 serve both as input and readout units.

In some embodiments, two or more tiles can be used in a cascaded configuration, as depicted in FIG. 4. The tiles are then operated in series. A first tile 10 is used for the forward pass, while the second tile 10a is used for the backward pass. The second tile 10a stores a transposed version of the coordinate matrix stored in the first tile 10. Yet, in that case too, it is not necessary to reprogram the coordinate values stored across the memory systems 156 of the tiles.

The above examples assume that one and/or two IMC devices 10 are sufficient to map the input data. Whether this is possible, however, depends on the size of the input data relative to the dimensions of the crossbar array structure 15, 15a. In embodiments where the size of the input data is incompatible with the dimensions of the crossbar array structure 15, the initial problem can still be decomposed into smaller vector-matrix operations, involving portions of input vectors and matrices, partitioned in accordance with the size of the array 15. All necessary operations can then be successively performed, using either a single tile 15 or several tiles 15, 15a. In the latter case, the partitioned operations are mapped onto different tiles. In that case, one may initially map the K centroid coordinate vectors and/or the N point coordinate vectors onto the two or more IMC devices 10 (i.e., prior to storing the N point coordinate vectors). As a result, the first vector-matrix multiplications and the second vector-matrix multiplications are distributed across the two or more IMC devices 10. Conversely, sub-dimensional vectors and matrices can be handled using a simple padding approach, which effectively mutes the non-used memory systems 156.

As illustrated above, there are a variety of application scenarios that may require more than one IMC device 10. So, embodiments may involve two or more IMC devices 10, 10a, each having a crossbar array structure 15, 15a as described earlier. The IMC devices 10, 10a may possibly be operated independently from each other, notably to accommodate oversized data. In some embodiments, the two IMC devices 10, 10a may be connected to each other, notably where the IMC devices are serially operated. The serial operation can allow for the implementation of the forward and backward pass, as assumed in FIG. 4.

There are further applications that may benefit from the use of several, connected IMC devices 10. For example, a first IMC device 10 may be used to perform S30, S50 the first and second vector-matrix multiplications, while another IMC device 10a can be used to average S60 the K column vectors. Indeed, the average operation performed at operation S60 can be computed based on the binary outputs of the scoring matrix, using an additional crossbar array 15a, which encodes such binary outputs as input data to perform the summing operation. Alternatively, the additional vector-matrix operations can also be done using the same scoring crossbar array 15, should the latter support the transpose operation, as noted earlier. In that case, the same tile can be used to perform both the forward pass and the backward pass.

In other variants, additional tiles are used to normalize the coordinates of the set of N points. Namely, this normalization can be performed based on a random projection encoding scheme, prior to storing at S20 the N point coordinate vectors. Various random projection encoding schemes are available, such as the so-called Gaussian and Sparse random projections. Such a projection can be performed thanks to an in-memory computational method, using one or more additional crossbar arrays. This is particularly useful for low dimensional data vectors. Thus, additional tiles can also be used to embed low dimensional input data into higher dimensions.

Where several tiles are involved, one possibility is to design the IMC system 10, as a 3-Dimensional in-memory computing device, where several crossbars are stacked on top of each other. Such IMC systems can then more conveniently be used as accelerators and be attached to a system 1, such as a composable disaggregated infrastructure including other types of accelerators.

In some embodiments, the discussed methods can be performed in accordance with a clustering algorithm based on a k-means method, whereby the user may initially choose the number of desired clusters. This number is accessed at operation S10 in the flow of FIG. 7. After that, the centroids are initialized at S15; e.g., the initial K centroids can be randomly picked, as in the k-means algorithm. Variants of k-means exist, which differ only in some aspects of the base algorithm. For example, the so-called K++ means algorithm provides an optimized initialization method. The first centroid is randomly picked from the dataset of points, while other centroids can be picked using previously picked centroids. Alternatively, the initialization may rely on multiple random vectors. The initialization may also exploit an upstream task or be performed iteratively.

Next, the K centroid coordinate vectors are typically refined S30-S60 iteratively, by repeatedly refining the K centroid coordinate vectors in accordance with operations S30 to S60. Such operations repeat as long as a termination criterion is not met (S70: No), see FIG. 7. The number of iterations may, for instance, be predetermined or adaptively selected based on the input data.

The IMC devices 10, 10a are typically connected to, and set in data communication with, an information-processing system 18, 20, whereby the IMC devices 10, can perform/operate S30, S50 by a processor of the information-processing system 18, 20. Such processor may also be used to perform the remaining operations, notably to determine S15 the K centroid coordinate vectors, determine S40 the K row vectors, and average S60 each of the K column vectors. The information-processing system 18, 20 may involve distinct a distinct processor. One may provide processing units 18, which are configured as near-memory processing units. For example, each processing unit 18 is configured as near-memory processing units with respect to a respective IMC devices 10, as shown in FIG. 2. This way, the near-memory processing unit 18 can efficiently determine S40 the K row vectors and average S60 each of the K column vectors.

In some embodiments, the method 700 is performed as follows. A client request is received by the system 1 at operation S5. Data is forwarded by the client 2 to the system 1, which preprocesses S8 such data, notably to check formats and rescale the data, if needed. The client requests further communications with a desired number of clusters, which is identified at operation S10—alternately, this number is automatically inferred. Initial centroid coordinate vectors are determined (e.g., at random) at operation S15, by the processor 20. The latter interacts with the IMC system 10 to store S20 point coordinate vectors across the memory systems of the IMC device(s) 10, 10a. The centroid coordinates are then iteratively refined S30-S70. The processor first instructs performing S30 dot products of centroid coordinate vectors and matrix of point coordinates (first vector-matrix multiplications), using the IMC device 10. Next, at operation S40, binary vectors (encoding maxima of columns of the resulting matrix) are determined, thanks to near-memory processor 18. At operation S50, the near-memory processor 18 instructs performing dot products of binary vectors and the transposed matrix of the point coordinates, using the same IMC device, which supports transposed matrix operations. At operation S60, the processor 18 collects output signals and averages the column vectors encoded therein, in accordance with the numbers of Is in the respective binary vectors. Operations S30-S60 repeat as long as the exit condition is not met (S70: No). Once the exit condition is met (S70: Yes, e.g., a predetermined number of iterations has been reached), the processor 20 stores the final centroid coordinates and returns S100 them to the client, unless the number of clusters is to be changed (S80: Yes). In that case, further iterations may be performed.

Computerized devices 10, 10a, 20 can be suitably designed for implementing embodiments of the present disclosure as described herein. In that respect, it can be appreciated that the methods described herein are largely non-interactive and automated. In example embodiments, the methods described herein can be implemented either in an interactive, partly interactive, or non-interactive system. The methods described herein can possibly be implemented in a combination of software and hardware. In example embodiments, the methods described herein are implemented in software, as an executable program, the latter executed by suitable information processing system 20, themselves causing to operate IMC systems 10, 10a as described earlier.

Aspects of the present disclosure are described herein with reference to flowchart illustrations and/or block diagrams of methods, apparatus (systems), and computer program products according to embodiments of the disclosure. Some of the blocks of the flowchart illustrations and/or block diagrams, and combinations of such blocks, can be implemented by computer readable program instructions.

While the present disclosure has been described with reference to a limited number of embodiments, variants, and the accompanying drawings, it will be understood by those skilled in the art that various changes may be made, and equivalents may be substituted without departing from the scope of the present disclosure. In particular, a feature (device-like or method-like) recited in a given embodiment, variant or shown in a drawing may be combined with or replace another feature in another embodiment, variant or drawing, without departing from the scope of the present disclosure. Various combinations of the features described in respect of any of the above embodiments or variants may accordingly be contemplated, that remain within the scope of the appended claims. In addition, many minor modifications may be made to adapt a particular situation or material to the teachings of the present disclosure without departing from its scope. Therefore, it is intended that the present disclosure is not limited to the particular embodiments disclosed, but that the present disclosure will include all embodiments falling within the scope of the appended claims. In addition, many other variants than explicitly touched above can be contemplated.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 of FIG. 8 contains an example of an environment for the execution of at least some of the computer code involved in performing the inventive methods, such as clustering data points using an in-memory computing system of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational operations to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Computer Technology and Computer Readable Media

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method, comprising:
determining, by an in-memory computing (IMC) system, K centroid coordinate vectors as K column vectors of dimension M, the K column vectors respectively representing normalized coordinates of K initial centroids of K clusters of a set of N points, wherein the IMC system comprises one or more IMC devices, each of the one or more IMC devices comprising a crossbar array structure including input lines and output lines interconnected at a cross-point defining cells, and each cross-point comprising a memory system;
storing N point coordinate vectors of dimension M across each memory system, wherein the N point coordinate vectors represent normalized coordinates of the set of N points and can be represented as an M× N matrix; and
refining the K centroid coordinate vectors, the refining comprising:
performing, by the IMC system, dot products of the K column vectors with the M× N matrix as first vector-matrix multiplications to obtain K intermediate vectors of dimension N, the intermediate vectors forming a K & N matrix;
determining K row vectors in accordance with maxima of each column of the K× N matrix;
performing, by the IMC system, dot products of the K row vectors with a transposed version of the M×N matrix as second vector-matrix multiplications to obtain the K column vectors; and
averaging each of the K column vectors according to values of component of respective ones of the K row vectors to obtain K averaged column vectors, where the K averaged column vectors correspond to the refined, K centroid coordinate vectors.

2. The computer implemented method according to claim 1, wherein:
the K row vectors are determined as K binary vectors encoding maxima of each column of the K×N matrix as ones, while remaining vector components consist of zeros; and
each of the K column vectors is averaged according to numbers of ones in respective ones of the K binary vectors.

3. The computer implemented method according to claim 2, wherein the K row vectors are determined by comparing output signals obtained from analog-digital converters in the output lines upon performing the first vector-matrix multiplications.

4. The computer implemented method according to claim 1, wherein a first IMC device of the one or more IMC device that support transposed matrix operations, wherein the first vector-matrix multiplications and the second vector-matrix multiplications are performed using a same memory configuration of the N point coordinate vectors as stored across the memory systems of the first IMC device.

5. The computer implemented method according to claim 4, wherein:
performing the first vector-matrix multiplications comprises applying electric signals encoding values of components of the K column vectors along input lines of the crossbar array structure of the first IMC device and measuring electric signals along output lines of the crossbar array structure of the first IMC device, and
performing the second vector-matrix multiplications comprises applying electric signals encoding values of components of the K row vectors along output lines of the crossbar array structure of the first IMC device and measuring electric signals along input lines of the crossbar array structure of the first IMC device.

6. The computer implemented method according to claim 1, wherein the K centroid coordinate vectors are iteratively refined by repeatedly refining the K centroid coordinate vectors.

7. The computer implemented method according to claim 1, wherein the method is performed in accordance with a clustering algorithm based on a k-means algorithm.

8. The computer implemented method according to claim 1, wherein the method further comprises:
operating processor of an information-processing system connected to the one or more IMC systems to determine the K centroid coordinate vectors, determine the K row vectors, and average each of the K column vectors.

9. The computer implemented method according to claim 8, wherein the information-processing system includes one or more processing units configured as near-memory processing units with respect to respective ones of the one or more IMC devices, the one or more processing units configured to determine the K row vectors and average each of the K column vectors.

10. The computer implemented method according to claim 8, wherein:
the information-processing system includes a second IMC device and a third IMC device from the one or more IMC devices; and
the first IMC device and the second IMC device are connected to each other.

11. The computer implemented method according to claim 10, wherein:
the first IMC device is used to perform the first vector-matrix multiplications and the second vector-matrix multiplications;
the second IMC device is used to perform to perform the averaging each of the K column vectors; and
normalizing the coordinates of the set of N points based on a random projection encoding scheme, prior to storing the N point coordinate vectors.

12. The computer implemented method according to claim 1, wherein:
the N point coordinate vectors are stored across the memory systems by a programming unit connected thereto.

13. The computer implemented method according to claim 10, wherein the method further comprises mapping the K centroid coordinate vectors and/or the N point coordinate vectors onto the two IMC devices, prior to storing the N point coordinate vectors, wherein the first vector-matrix multiplications and the second vector-matrix multiplications are distributed across the two IMC devices.

14. The computer implemented method according to claim 8, wherein said information-processing system and the one or more IMC systems form part of a distributed computing system and the method is performed online, in response to a client query.

15. An information processing system for clustering a set of N points, the information processing system comprising:
an in-memory computing (IMC) system which comprises one or more IMC devices, each having a crossbar array structure comprising input lines and output lines interconnected at cross-points defining cells, the cross-points comprising respective memory systems, and
a processor, which is connected to the IMC system, wherein the processor is configured to:
determine K centroid coordinate vectors as K column vectors of dimension M, the K column vectors respectively representing normalized coordinates of K initial centroids of K clusters of the set of N points;
operate the IMC system to store N point coordinate vectors of dimension M across its memory systems, wherein the N point coordinate vectors represent normalized coordinates of the set of N points and can be represented as an M× N matrix; and
refine the K centroid coordinate vectors by:
performing, using the IMC system, dot products of the K column vectors with the M× N matrix as first vector-matrix multiplications to obtain K intermediate vectors of dimension N, the intermediate vectors forming a K×N matrix;
determining K row vectors in accordance with maxima of each column of the K×N matrix;
performing, using the IMC system, dot products of the K row vectors with a transposed version of the M× N matrix as second vector-matrix multiplications to obtain K column vectors; and
averaging each of the K column vectors according to values of component of respective ones of the K row vectors to obtain K averaged column vectors, the latter corresponding to the refined, K centroid coordinate vectors.

16. The information processing system according to claim 15, wherein the IMC system includes an IMC device that supports transposed matrix operations, wherein the first vector-matrix multiplications and the second vector-matrix multiplications are performed using a same memory configuration of the N point coordinate vectors as stored across the memory systems of the IMC device in operation.

17. The information processing system according to claim 15, wherein the processor includes one or more processing units configured as near-memory processing units with respect to a respective one of the one or more IMC devices.

18. The information processing system according to claim 15, wherein:
said information-processing system includes two IMC devices, each having a crossbar array structure including input lines and output lines, and
the two IMC devices are connected to each other.

19. The information processing system according to claim 18, wherein the method further comprises one or more programming units configured to store the N point coordinate vectors across the memory systems.

20. A computer program product, the computer program product comprising a computer readable storage medium having program instructions embodied therewith, the program instructions executable by a processing unit to cause the processing unit to:
determine, by an in-memory computing (IMC) system, K centroid coordinate vectors as K column vectors of dimension M, the K column vectors respectively representing normalized coordinates of K initial centroids of K clusters of the set of N points, wherein the IMC system includes one or more IMC devices, each of the one or more IMC devices has a crossbar array structure including input lines and output lines interconnected at a cross-point defining cells, and each cross-point includes a memory system;
store N point coordinate vectors of dimension M across the memory systems, wherein the N point coordinate vectors represent normalized coordinates of the set of N points and can be represented as an M× N matrix; and
refine the K centroid coordinate vectors by:
perform, by the IMC system, dot products of the K column vectors with the M× N matrix as first vector-matrix multiplications to obtain K intermediate vectors of dimension N, the intermediate vectors forming a K & N matrix, wherein;
determine K row vectors in accordance with maxima of each column of the K×N matrix;
perform, by the IMC system, dot products of the K row vectors with a transposed version of the M× N matrix as second vector-matrix multiplications to obtain K column vectors; and
average each of the K column vectors according to values of component of respective ones of the K row vectors to obtain K averaged column vectors, the latter corresponding to the refined, K centroid coordinate vectors.
